(19) United States
(12) Patent Application Publication
(10) Pub. No.: US 2025/0191371 A1
(43) Pub. Date: Jun. 12, 2025

(54) ARTIFICIAL INTELLIGENCE SYSTEMS AND METHODS FOR ANALYZING IMAGES AND APPLYING A SCORING MODEL

(71) Applicant: State Farm Mutual Automobile Insurance Company, Bloomington, IL (US)

(72) Inventor: Saurabh Parkash, McKinney, TX (US)

(21) Appl. No.: 18/531,367

(22) Filed: Dec. 6, 2023

(51) Int. Cl. G06V 20/52; G06T 7/00; G06V 10/75; H04N 7/18; H04N 23/60

(52) U.S. Cl. CPC G06V 20/52; G06T 7/0002; G06V 10/751; H04N 23/64; G06T 2207/20081; G06T 2207/30184

(57) ABSTRACT

A computer system is provided and is programmed to: (1) store one or more models for analyzing images to identify issues associated with the images; (2) store a plurality of initial images of a location; (3) receive a plurality of current images of the location; (4) execute the one or more models to compare the plurality of initial images to the plurality of current images; (5) detect one or more issues at the location based upon an output of the execution of the one or more models; and (6) transmit one or more notifications based upon the one or more issues at the location.

### FIELD OF THE DISCLOSURE

The present disclosure relates to an image analysis tool, and more particularly, to an artificial intelligence-based system and method for analyze images and applying a scoring model to detect, identify, and remediate detected issues.

### BACKGROUND

Digital images (e.g., photos and/or videos) are oftentimes captured by cameras and stored on memory. In some cases, those digital images are shared with other systems that may process those images further. In some cases, those images may need to be evaluated before being shared so that the information included in the images is better understood and/or labeled so that the further processing may happen. Evaluation of such images may be a labor-intensive process and may be dependent upon subject matter expertise.

Using known systems for evaluating an image, it is understood that the more complicated the image, the greater the likelihood may be that the image will be mis-labeled or mis-identified. Also, using the known systems for artificial intelligence-based image analysis, the more complicated the image, the more computation resources may be needed to evaluate the image. In many cases, the images may contradict some information provided through another means. This may occur as a result of information being updated after the picture was captured. Furthermore, differences in angle, lighting, resolution, coloration, and other differences greatly increase the processing cost of image analysis systems.

Currently, there are approximately 44 million households that are tenants in the United States (2019 American Community Survey). The management of such rental properties is laborious, time consuming, unorganized, and requires a great deal of human interaction. In many situations, a property manager or representative has to manually review property for damages that may have been caused while the property is being rented. This also requires scheduling with the tenant to determine when a good time is to inspect the property. While frequent inspections may disturb the tenants, infrequent inspections may allow issues to grow between inspections. Furthermore, tenants might not be knowledgeable to recognize when issues may be imminent. Accordingly, it would be desirable to have a system to improve analysis of rental properties while reducing the inconvenience of the tenant and while reducing the expense associated therewith.

### BRIEF SUMMARY

The present embodiments may relate to, inter alia, an image analysis tool, and more particularly, to an artificial intelligence-based system and method for analyzing images to detect, identify, and resolve issues that may be present at properties. The systems and methods described herein may provide for analyzing a plurality of images to detect and identify any issues, changes, and/or damages associated with those images and determine steps to resolve those issues. The present systems and methods may further include a plurality of models trained to recognize items, fixtures, appliances, and/or features at properties in the images, where the items, fixtures, appliances, and/or features are analyzed to identify any potential issues in the images.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (1) store one or more models for analyzing images to identify issues associated with the images; (2) store a plurality of initial images of a location; (3) receive a plurality of current images of the location; (4) execute the one or more models to compare the plurality of initial images to the plurality of current images; (5) detect one or more issues at the location based upon an output of the execution of the one or more models; and/or (6) transmit one or more notifications based upon the one or more issues at the location. The computer system may include additional, less, or alternate functionality, including that discussed elsewhere herein.

In another aspect, a computer-implemented method may be provided. The computer-implemented method may be performed by a computer device including at least one processor in communication with at least one memory device. The method may include: (1) storing one or more models for analyzing images to identify issues associated with the images (e.g., the physical items included within the images); (2) storing a plurality of initial images of a location; (3) receiving a plurality of current images of the location; (4) executing the one or more models to compare the plurality of initial images to the plurality of current images; (5) detecting one or more issues at the location based upon an output of the execution of the one or more models; and/or (6) transmitting one or more notifications based upon the one or more issues at the location. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store one or more models for analyzing images to identify issues associated with the images; (2) store a plurality of initial images of a location; (3) receive a plurality of current images of the location; (4) execute the one or more models to compare the plurality of initial images to the plurality of current images; (5) detect one or more issues at the location based upon an output of the execution of the one or more models; and/or (6) transmit one or more notifications based upon the one or more issues at the location. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram of an exemplary rental property in accordance with at least one embodiment.

FIG. 2 illustrates a block diagram of an exemplary process of identifying issues in the exemplary rental property shown in FIG. 1.

FIG. 3 illustrates an exemplary computer-implemented process of identifying issues in the exemplary rental property shown in FIG. 1.

FIG. 4 illustrates an exemplary computer system for performing the processes shown in FIGS. 2 & 3.

FIG. 5 illustrates an exemplary configuration of a user computer device shown in FIG. 2, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based system and method that uses artificial intelligence tools to analyze images captured by a camera to detect, identify, and remediate detected issues identified within the images. In one exemplary embodiment, the process may be performed by an image analysis (IA) computer device. In the exemplary embodiment, the IA computer device may be in communication with one or more user devices, one or more analysis models, and/or one or more tenant computer devices. As described below in further detail, the IA computer system includes multiple, image evaluating models that are trained to recognize different types of equipment and fixtures in and around a building, such as a rental apartment and/or other location. The systems and methods described herein automate rental and building management to improve upkeep, reduce property loses, and reduce tenant inconvenience.

The IA computer system allows property management companies and/or landlords to set-up property accounts with pictures of the property prior to the tenant taking possession of the property. These property accounts are stored as unique data structures within a database for later comparison and analysis. The IA computer system requests that the tenant uploads pictures of the property on a regular basis, e.g., monthly, etc. The IA computer system uses deep artificial intelligence (AI) image comparison models to compare the images provided by the property management company/landlord to those provided by the tenant. The IA computer system determines the validity of the images including at least the timing of when the photographs were taken and the location of the photographs, and further determines how similar the images are to the stored images, and in some embodiments provides a scoring for the similarity. In addition, the IA computer system provides questionnaires and/or surveys to the tenants with questions about the property and its upkeep. The IA computer system captures their answers and provides the answers to the property management companies and/or landlords. The IA computer system may recognize one or more trends based upon the answers and highlight those trends to the property management companies and/or landlords. The trends may indicate issues at that specific property or a potential issue across several properties at the same location.

In some embodiments, the property management company/landlord records an initial video of the property, and stores the captured images as a data structure within memory that is easily retrievable and comparable for AI purposes. The tenant then provides a live video of the property on a monthly (or some other time period) basis. The image comparison models analyze the live video in view of the initially stored video and determines if there are any differences and/or changes in the items includes within the captured images. The newly received images are then stored with the previously stored images to create an updated data structure of images that are linked to a timeline of when the images were captured along with location data.

In the exemplary embodiment, the IA computer device has access one or more databases of property images. The images include images of before and after pictures of issues and/or problems that have occurred at the property. For example, the images may include images of a water heater leading up to and after the water heater developed a leak. In another example, the images may include images of the pipes under a sink before and after a leak has occurred. The images may include before and after images of water damage to floors, ceilings, and/or walls. The IA computer device uses the plurality of property images to train one or more databases to recognize and categorize images to detect potential issues in images. The one or more models are trained to recognize appliances, fixtures, and other features of buildings. The one or more models are also trained to classify images with evidence of potential issues with those appliances, fixtures, and other features.

In the exemplary embodiment, a property management company/landlord takes a plurality of images of a property prior to renting the property to a tenant. These property accounts are stored as unique data structures within a database for later comparison and analysis. The property may be an apartment, a house, a building, an office, a storefront, and/or any other property that may be rented. The property management company/landlord uploads the plurality of images to the IA computer device for storage as unique data structure that includes the images but also other metadata such as the geographical location of where the images were captured along with a date/time of capturing the images. In some embodiments, the IA computer device takes the date and time for the images from the metadata of the images. In some further embodiments, the property management company/landlord uses their mobile device with a camera to live stream the images and/or video of the property to the IA computer device. In additional embodiments, the mobile device may include a GPS (Global Positioning System) and the location information associated with each image is uploaded to the IA computer device. In some embodiments, the IA computer device instructs the property management company/landlord to capture images of certain items, fixtures, appliances, and/or features and at specific angles. The IA computer device may then compare the captured images to a reference sample image to confirm that the captured image is sufficient to compare the captured images to the stored images and identify any issues using the AI model. If the IA computer device determines that the captured image is not sufficient, then it will automatically prompt the photographer to capture new images that will satisfy the IA computer device.

In the exemplary embodiment, the IA computer device requests that the tenant takes images of the property on a regular basis, e.g., once a month. The IA computer device may instruct the tenant by causing directions to be displayed on the user device which items, fixtures, appliances, and/or features to capture and at which angles. The tenant may use their mobile computing device, such as a smart phone and/or a tablet, to capture the images. In some embodiments, the images are still images. In other embodiments, the tenant captures video. In additional embodiments, the images and/or video are captured live and automatically uploaded to the IA computer device. In at least one embodiment, the IA computer device analyzes the metadata of the images to confirm that the images and/or video are current. In additional embodiments, the mobile device may include a GPS and the location information associated with each image is uploaded to the IA computer device.

In the exemplary embodiment, the IA computer device analyzes the images for differences and potential issues including damage to items included within the images or items requiring maintenance, etc. In at least one embodiment, the IA computer device compares the images provided by the property management company/landlord to the most recent images provide by the tenant. The IA computer device scores the images to determine how much of a difference or changes there is between any of the images of the same items, fixtures, appliances, and/or features. Then the IA computer device analyzes the scores. If the score is below a predetermined threshold, the IA computer device stores the images and the scores and waits for the next set of images from the tenant. If the score exceeds a predetermined threshold for requiring follow up or maintenance, the IA computer device may determine what the issue is, such as by executing one or more models to determine why there is a difference between the images and what the reason for the difference is. For example, the IA computer device may determine that a water heater is beginning to leak based upon the build-up of sediment on the side of the water heater. The IA computer device may also determine that the reason for the difference in images is something minor, for example, someone in the tenant's household colored the water heater with markers or added stickers to the side of the fixture which may be easily address by the tenant and not require landlord follow up.

If the IA computer device determines that there is an issue, the IA computer device may transmit one or more notifications to individuals, such as the property management company/landlord. In further embodiments, the IA computer device may schedule an appointment with a maintenance person or a third-party service provider. The IA computer device may also place an order for one or more replacement items or items that may be needed to resolve the issue.

In at least one embodiment, the IA computer device compares the images over the period of time to detect any trends and/or wear-and-tear on the items, fixtures, appliances, and/or features.

In at least one embodiment, the IA computer device generates a rebate, refund, and/or discount for the tenant based upon the condition of the property. The tenant may receive a discount on their rent payment for the next month if the images do not show damage or unexpected wear-and-tear.

In further embodiments, the property management company/landlord or the tenant takes images of the rental property after the tenant has moved out. These images are uploaded to the IA computer device. The IA computer device compares the initial images from the property management company/landlord to the after move-out images to determine if the tenant's security deposit is to be returned. In some embodiments, the IA computer device initiates the return of the security deposit. In some of these embodiments, the tenant is instructed to take images of the property prior to moving in to show the condition of the property on move-in day. These tenant accounts are stored as unique data structures within a database for later comparison and analysis. This covers the changes that may have occurred between when the property management company/landlord took the images and when the tenant moves-in.

In some further embodiments, the plurality of scores overtime associated with a tenant are combined to create an overall rental score for the tenant that represents if the tenant takes proper care of the property. Other property management companies/landlords would be more likely to rent to a tenant that has a good rental score. In other words, the unique data structure of captured images with associated metadata for a particular property having a particular tenant are saved an updated, and are searchable by an identifier associated with the particular tenant. By creating this unique data structure, the database becomes searchable by the tenant's identifier so that future landlords can search and determine whether a particular tenant is a high risk tenant based on past experience for future rental properties.

In still further embodiments, the plurality of scores over time associated with a property management company/landlord are combined to create an overall landlord score for the property management company/landlord. This score represents how likely there are to be issues with properties rented from the property management company/landlord. This score may be released to potential tenants as a way to rate different property management companies/landlords. Furthermore, this score may be provided to insurance companies to inform them the likelihood that tenants at those properties may have claims for loss, such as for personal property damaged by poor maintenance.

In some further embodiments, the some or all of the images are protected and/or secured to protect the privacy of the individuals living in the property. In these embodiments, the IA computer device only requests images of certain appliances and/or fixtures, such as hot water heaters and underneath sinks. In some of these embodiments, the IA computer device crops out other items, such as the bottles stored under the sink, to protect the privacy of the tenants.

In additional embodiments, the IA computer device controls the camera of the user's mobile device when taking images of the property. For example, the IA computer device instructs the user where to stand and at what angle to point to take the image. This may include an augmented reality overlay that provides an outline or other guide to show the user what to capture. In these embodiments, the IA computer device may review the feed from the camera and automatically capture the image when the proper item, fixture, and/or appliance is in view at the proper angle.

In some further embodiments, the IA computer device also receives audio information from the user computer devices. The IA computer device then analyzes the audio to detect potential issues from the audio, such as a running toilet, odd noises from the furnace or air conditioning etc.

In still further embodiments, the IA computer device may receive images of common areas to determine if there are any images in those areas of the property. Common areas may include, but are not limited to, hallways, a lobby, a fitness center, a pool, a mail room, and/or a common break room.

In some embodiments, the IA computer device manages a list of repairs that are needed based on the analysis of images from a plurality of properties. The IA computer device may prioritize these repairs based upon the urgency of the repair and the potential for additional damage to be caused by the associated issue. A leaky faucet would be rated at a lower priority than a constant leak from a water heater or a toilet.

While the above describes using the systems and processes described herein for analyzing property, one having skill in the art would understand that these systems and methods may also be used for classifying items, such as vehicles, antiques, and/or other objects that need to be analyzed and classified.

At least one of the technical problems addressed by this system may include: (i) large amounts of training data required to recognize different types issues with property; (ii) reducing the amount of time required to inspect properties; (iii) reduced coordination required to inspect properties; (iv) improved accuracy in detecting issues at properties; (v) reduced turnaround time on detecting and resolving issues at properties; and/or (vi) improved upkeep of properties.

A technical effect of the systems and processes described herein may be achieved by performing at least one of the following steps: a) store one or more models for analyzing images to identify issues associated with the images; b) store a plurality of initial images of a location; c) receive a plurality of current images of the location; d) execute the one or more models to compare the plurality of initial images to the plurality of current images; e) detect one or more issues at the location based upon an output of the execution of the one or more models; f) transmit one or more notifications based upon the one or more issues at the location; g) receive a plurality of historical images of a plurality of properties; h) generate the one or more models based upon the plurality of historical images; i) receive the plurality of initial images from a user computer device associated with the location; j) transmit instructions to the user computer device for capturing the plurality of initial images; k) control the user computer device to capture the plurality of initial images; l) transmit instructions to a user computer device associated with a tenant of the location, wherein the instructions include one or more items to capture the plurality of current images of at the location; m) wherein the instructions include an overlay to display on a display screen of the user computer device; n) control the user computer device to capture the plurality of current images; o) transmit the instructions to the user computer device of the tenant on a periodic basis; p) transmit the one or more notifications based upon the one or more issues at the location to a service provider to resolve the one or more issues; q) receive a plurality of sets of current images of a first location over a plurality of periods of time; r) compare the plurality of sets of current images of the first location to determine at least one trend at the first location; s) receive a plurality of sets of current images of a first location over a plurality of periods of time; t) calculate a score for a tenant at the first location based upon the plurality of sets of current images of the first location; u) receive a plurality of sets of current images from one or more locations associated with a landlord; and v) calculate a score for the landlord based upon the plurality of sets of current images of the one or more locations.

### Exemplary Property

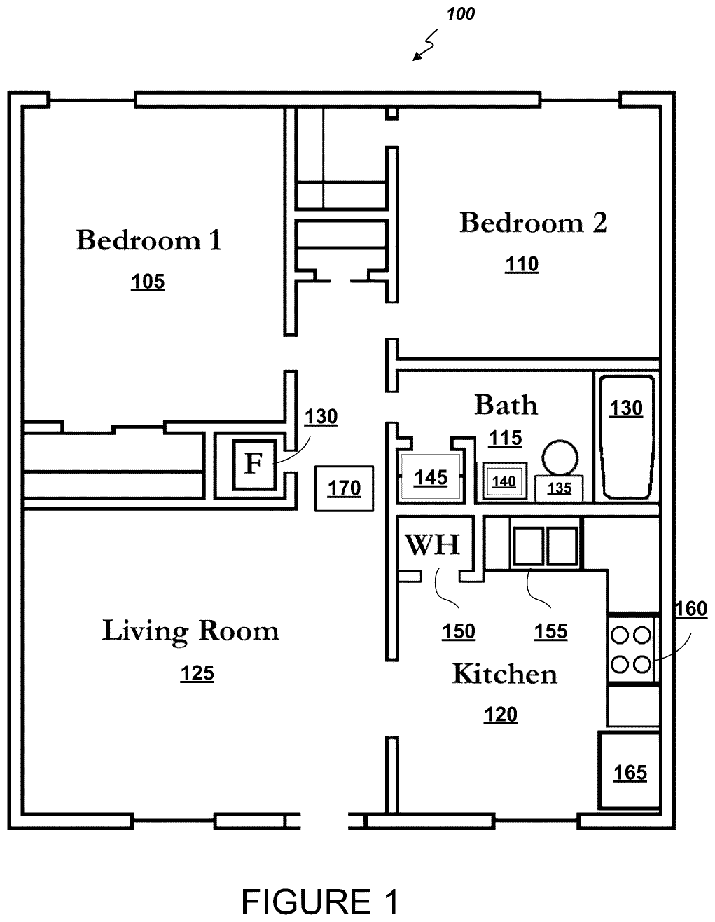

FIG. 1 illustrates a block diagram of an exemplary rental property 100 in accordance with at least one embodiment. The rental property 100 includes a plurality of rooms including bedroom 1 105, bedroom 2, 110, a bath 115, a kitchen 120, and a living room 125, for example. Other rental properties 100 may have other configurations of rooms, other features, fixtures, and/or appliances.

In rental property 100, the bath 115 includes a shower/tub 130, a toilet 135, a sink 140 and/or a washer/dryer combo 145. The kitchen 120 includes a water heater 150, a sink 155, a stove/oven 160, and/or a refrigerator 165. The rental property 100 also includes a furnace 170. A user 175 may travel around the rental property 100 and capture images of the different appliances and fixtures.

While FIG. 1 illustrates a residential rental property 100, one having skill in the art would understand that the systems and methods described herein would work with other types of rental property, such as commercial rental property, including, but not limited to, storefronts, offices, and other commercial rental properties.

### Exemplary Process for Identifying Issues

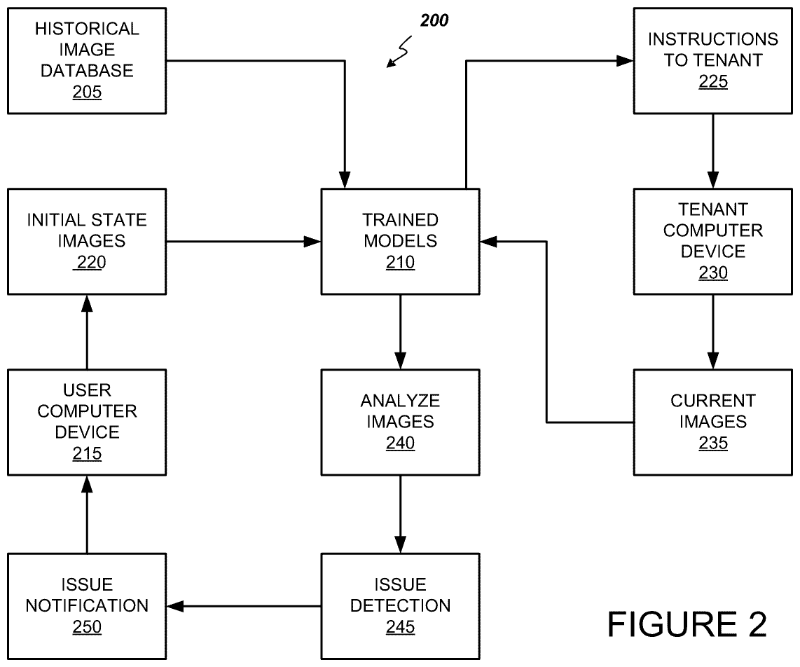

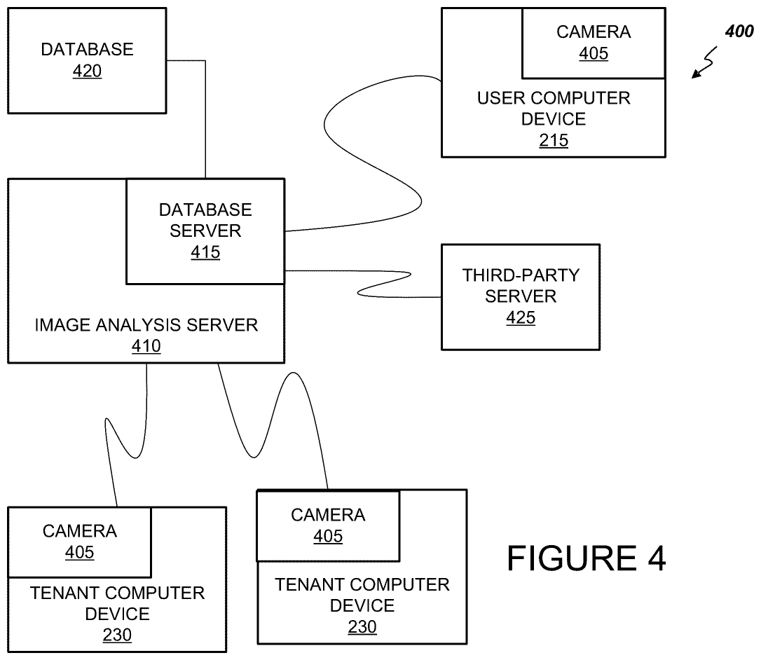

FIG. 2 illustrates a block diagram of an exemplary process 200 of identifying issues in the exemplary rental property 100 (shown in FIG. 1). In some embodiments, process 200 is performed by an image analysis (IA) computer device 410 (shown in FIG. 4).

In the exemplary embodiment, the IA computer device 410 accesses a historical image database 205. The historical image database 205 includes a plurality of images of different items, appliances, fixtures, and/or features that may be found on a rental property 100. The images include with and without different issues and/or problems that require remediation and/or repair to resolve. The IA computer device 410 uses the historical image database 205 to train one or more models 210 to recognize the different items, appliances, fixtures, and/or features as well as detect when issues have occurred or are about to occur with those items, appliances, fixtures, and/or features. In some embodiments, the IA computer device 410 trains multiple models 210 where the different models are trained to recognize issues with different items, appliances, fixtures, and/or features. For example, one model 210 is trained to recognize issues with water heaters 150 (shown in FIG. 1) while another model 210 is trained to recognize issues with sinks 140 and 155 (both shown in FIG. 1).

In the exemplary embodiment, the IA computer device 410 receives a set of initial state images 220 from a user computer device 215 associated with a property management company/landlord. The set of initial state images 220 are of the property 100 and show the state or condition of different items, appliances, fixtures, and/or features of the property 100 before a tenant has moved into the property 100. In some embodiments, the IA computer device 410 takes the date and time for the images 220 from the metadata of the images 220. In some further embodiments, the property management company/landlord uses their user computer device 215 with a camera to live stream the images and/or video of the property 100 to the IA computer device 410. In additional embodiments, the user computer device 215 may include a GPS (Global Positioning System) and the location information associated with each image 220 is uploaded to the IA computer device 410. In some embodiments, the IA computer device 410 instructs the property management company/landlord to capture images 220 of certain items, fixtures, appliances, and/or features and at specific angles by causing directions to be displayed on the user computer device 215 which items, fixtures, appliances, and/or features to capture and at which angles. The IA computer device 410 stores the initial captured images 220 as a data structure within memory that is easily retrievable and comparable for AI purposes. After the tenant has taken possession of the property 100, the IA computer device 410 transmits instructions 225 to the tenant via a tenant computer device 230. The instructions 225 are for the tenant to capture images 235 of the different items, appliances, fixtures, and/or features of the property 100. In some embodiments, the instructions 225 are for all of the same items, appliances, fixtures, and/or features in the initial state images 220. In other embodiments, the instructions 225 are for a subset of the same items, appliances, fixtures, and/or features in the initial state images 220. The tenant uses the tenant computer device 230 to capture the current images 235, which are provided to the IA computer device 410. The IA computer device 410 uses image comparison models analyze the tenant captured images 235 in view of the initially stored images 220 and determines if there are any differences and/or changes in the items includes within the captured images. The IA computer device 410 stores the newly received images 235 with the previously stored images 220 to create an updated data structure of images that are linked to a timeline of when the images were captured along with location data

In the exemplary embodiment, the IA computer device 410 requests that the tenant takes images of the property 100 on a regular basis, e.g., once a month. The IA computer device 410 may instruct the tenant which items, fixtures, appliances, and/or features to capture and at which angles by causing directions to be displayed on the tenant computer device 230 which items, fixtures, appliances, and/or features to capture and at which angles. The tenant may use their tenant computer device 230, such as a smart phone and/or a tablet, to capture the images 235. In some embodiments, the images 235 are still images. In other embodiments, the tenant captures video. In additional embodiments, the images and/or video are captured live and automatically uploaded to the IA computer device 410. In at least one embodiment, the IA computer device 410 analyzes the metadata of the images 235 to confirm that the images 235 and/or video are current. In additional embodiments, the tenant computer device 230 may include a GPS and the location information associated with each image 235 is uploaded to the IA computer device 410.

The IA computer device 410 may then compare the initially captured images 215 and/or the current images 235 to a reference sample image to confirm that the captured image 215 or 235 is sufficient to compare to other images to be able to identify any issues using the AI models 210. If the IA computer device 410 determines that the captured image is not sufficient, then it will automatically prompt the photographer to capture new images that will satisfy the IA computer device 410 and the models 210. In the exemplary embodiment, the IA computer device 410 uses the trained models 210, the initial state images 220, and the current images 235 to analyze 240 the images 235.

In the exemplary embodiment, the IA computer device analyzes 240 the images 220 and 235 for differences and potential issues including damage to items included within the images or items requiring maintenance, etc. In at least one embodiment, the IA computer device 410 compares the images 220 provided by the property management company/landlord to the most recent images 235 provide by the tenant. The IA computer device 410 scores the images 235 to determine how much of a difference there is between any of the images of the same items, fixtures, appliances, and/or features. Then the IA computer device 410 analyzes the scores. If the score is below a predetermined threshold, the IA computer device 410 stores the images 235 and the scores and waits for the next set of images 235 from the tenant. If the score exceeds a predetermined threshold for requiring follow up or maintenance, the IA computer device 410 may determine 245 what the issue is, such as by executing one or more models 210 to determine why there is a difference between the images 220 and 235 and what the reason for the difference is. For example, the IA computer device 410 may determine 245 that a water heater 150 is beginning to leak based upon the build-up of sediment on the side of the water heater 150. The IA computer device 410 may also determine 245 that the reason for the difference in images 220 and 235 is something minor, for example, someone in the tenant's household colored the water heater 150 with markers or added stickers to the side of the fixture which may be easily address by the tenant and not require landlord follow up. The IA computer device 410 may ask the tenant to remove the marks on the water heater 150 and retake the images 235 of the water heater 150.

If the IA computer device 410 determines 245 that there is an issue, the IA computer device 410 may transmit one or more notifications 250 to individuals, such as the property management company/landlord via the user computer device 215. In further embodiments, the IA computer device 410 may schedule an appointment with a maintenance person or a third-party service provider. The IA computer device 410 may also place an order for one or more replacement items or items that may be needed to resolve the issue.

In at least one embodiment, the IA computer device 410 compares the images 235 over the period of time to detect any trends and/or wear-and-tear on the items, fixtures, appliances, and/or features.

In at least one embodiment, the IA computer device 410 generates a rebate, refund, and/or discount for the tenant based upon the condition of the property 100. The tenant may receive a discount on their rent payment for the next month if the images 235 do not show damage or unexpected wear-and-tear.

In further embodiments, the property management company/landlord or the tenant takes images 235 of the rental property after the tenant has moved out. These images 235 are uploaded to the IA computer device 410. The IA computer device 410 compares the initial images 220 from the property management company/landlord to the after move-out images 235 to determine if the tenant's security deposit is to be returned. In some embodiments, the IA computer device 410 initiates the return of the security deposit. In some of these embodiments, the tenant is instructed to take images of the property prior to moving in to show the condition of the property 100 on move-in day. These tenant accounts are stored as unique data structures within a database for later comparison and analysis. This covers the changes that may have occurred between when the property management company/landlord took the images 220 and when the tenant moves-in.

In some further embodiments, the plurality of scores overtime associated with a tenant are combined to create an overall rental score for the tenant that represents if the tenant takes proper care of the property 100. Other property management companies/landlords would be more likely to rent to a tenant that has a good rental score. In other words, the unique data structure of captured images with associated metadata for a particular property having a particular tenant are saved an updated, and are searchable by an identifier associated with the particular tenant. By creating this unique data structure, the database becomes searchable by the tenant's identifier so that future landlords can search and determine whether a particular tenant is a high risk tenant based on past experience for future rental properties.

In still further embodiments, the plurality of scores over time associated with a property management company/landlord are combined to create an overall landlord score for the property management company/landlord. This score represents how likely there are to be issues with properties 100 rented from the property management company/landlord. This score may be released to potential tenants as a way to rate different property management companies/landlords. Furthermore, this score may be provided to insurance companies to inform them the likelihood that tenants at those properties 100 may have claims for loss, such as for personal property damaged by poor maintenance.

In some further embodiments, the some or all of the images 235 are protected and/or secured to protect the privacy of the individuals living in the property 100. In these embodiments, the IA computer device 410 only requests images of certain appliances and/or fixtures, such as hot water heaters 150 and underneath sinks 140 and 155. In some of these embodiments, the IA computer device 410 crops out other items, such as the bottles stored under the sink, to protect the privacy of the tenants.

In additional embodiments, the IA computer device 410 controls the camera of the user's computer device 215 or 230 when taking images of the property 100. For example, the IA computer device 410 instructs the user where to stand and at what angle to point to take the image. This may include an augmented reality overlay that provides an outline or other guide to show the user what to capture. In these embodiments, the IA computer device 410 may review the feed from the camera and automatically capture the image 220 and 235 when the proper item, fixture, and/or appliance is in view at the proper angle.

In some further embodiments, the IA computer device 410 also receives audio information from the user computer devices 230. The IA computer device 410 then analyzes the audio to detect potential issues from the audio, such as a running toilet, odd noises from the furnace or air conditioning, etc.

In still further embodiments, the IA computer device 410 may receive images of common areas to determine if there are any images in those areas of the property 100. Common areas may include, but are not limited to, hallways, a lobby, a fitness center, a pool, a mail room, and/or a common break room.

In some embodiments, the IA computer device 410 manages a list of repairs that are needed based on the analysis 240 of images 235 from a plurality of properties 100. The IA computer device 410 may prioritize these repairs based upon the urgency of the repair and the potential for additional damage to be caused by the associated issue. A leaky faucet would be rated at a lower priority than a constant leak from a water heater 150 or a toilet 135 (shown in FIG. 1).

In additional embodiments, the IA computer device 410 provides questionnaires and/or surveys to the tenants with questions about the property 100 and its upkeep. The IA computer device 410 captures their answers and provides the answers to the property management companies and/or landlords. The IA computer device 410 may recognize one or more trends based upon the answers and highlight those trends to the property management companies and/or landlords. The trends may indicate issues at that specific property 100 or a potential issue across several properties 100 at the same location.

In still further embodiments, the IA computer device 410 stores the initial images 220 and the current images 235 in a data structure configured to organize the images 220 and 235 to be retrieved by AI models 210. The organization of the data structure allows the AI models 210 to easily retrieve and compare images in an efficient manner. In these embodiments, the IA computer device 410 also stores metadata for each image 220 and 235. In some embodiments, the IA computer device 410 parses the metadata to create a timeline of images as a part of organizing the images 220 and 235.

While the above describes using the systems and processes described herein for analyzing property 100, one having skill in the art would understand that these systems and methods may also be used for classifying items, such as vehicles, antiques, and/or other objects that need to be analyzed and classified.

### Exemplary Process for Identifying Issues

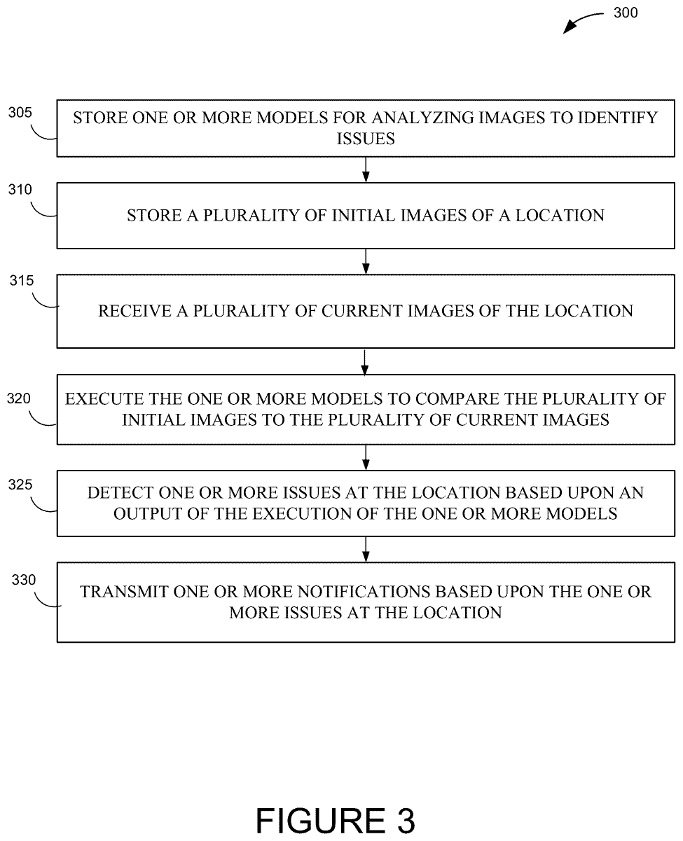

FIG. 3 illustrates an exemplary computer-implemented process 300 of identifying issues in the exemplary rental property shown in FIG. 1. Process 300 may be implemented by a computing device, for example IA computer device 410 (shown in FIG. 4). In the exemplary embodiment, IA computer device 410 may be in communication with a user computer device 215 (shown in FIG. 2), one or more tenant computer devices 230 (shown in FIG. 2), and/or third-party server 425 (FIG. 4).

In the exemplary embodiment, the IA computer device 410 stores 305 one or more models 210 for analyzing 240 images to identify issues 245 (all shown in FIG. 2) associated with the images. In the exemplary embodiment, the IA computer device 410 stores 310 a plurality of initial images 220 of a location 100 (shown in FIG. 1). In the exemplary embodiment, the IA computer device 410 receives 315 a plurality of current images 235 (shown in FIG. 2) of the location 100. In the exemplary embodiment, the IA computer device 410 executes 320 the one or more models 210 to compare the plurality of initial images 220 to the plurality of current images 235. In the exemplary embodiment, the IA computer device 410 detects 325 one or more issues 245 at the location 100 including damage to items included within the images or items requiring maintenance, etc. based upon an output of the execution of the one or more models 210. In the exemplary embodiment, the IA computer device 410 transmits 330 one or more notifications 250 (shown in FIG. 2) based upon the one or more issues 245 at the location 100.

In further embodiments, the IA computer device 410 receives a plurality of historical images 205 (shown in FIG. 2) of a plurality of properties 100. The IA computer device 410 generates the one or more models 210 based upon the plurality of historical images 205.

In further embodiments, the IA computer device 410 receives the plurality of initial images 220 from a user computer device 215 (shown in FIG. 2) associated with the location 100. The IA computer device 410 transmits instructions to the user computer device 215 for capturing the plurality of initial images 220. The IA computer device 410 controls the user computer device 215 to capture the plurality of initial images 220. The IA computer device 410 stores the initial captured images 220 as a data structure within memory that is easily retrievable and comparable for AI purposes.

In further embodiments, the IA computer device 410 transmits instructions 225 to a user computer device 230 associated with a tenant of the location 100. The instructions include one or more items to capture in the plurality of current images 235 of at the location 100. The instructions 225 include an overlay to display on a display screen of the user computer device 230. The IA computer device 410 controls the user computer device 230 to capture the plurality of current images 235. The IA computer device 410 transmits the instructions 225 to the user computer device 230 of the tenant on a periodic basis.

In further embodiments, the IA computer device 410 transmits the one or more notifications 250 based upon the one or more issues at the location 100 to a service provider to resolve the one or more issues.

In some embodiments, the IA computer device 410 uses image comparison models analyze the tenant captured images 235 in view of the initially stored images 220 and determines if there are any differences and/or changes in the items includes within the captured images. The IA computer device 410 stores the newly received images 235 with the previously stored images 220 to create an updated data structure of images that are linked to a timeline of when the images were captured along with location data

In further embodiments, the IA computer device 410 receive a plurality of sets of current images 235 of a first location 100 over a plurality of periods of time. The IA computer device 410 compares the plurality of sets of current images 235 of the first location 100 to determine at least one trend at the first location 100.

In further embodiments, the IA computer device 410 receives a plurality of sets of current images 235 of a first location 100 over a plurality of periods of time. The IA computer device 410 calculates a score for a tenant at the first location 100 based upon the plurality of sets of current images 235 of the first location 100.

In further embodiments, the IA computer device 410 receives a plurality of sets of current images 235 from one or more locations 100 associated with a landlord. The IA computer device 410 calculates a score for the landlord based upon the plurality of sets of current images 235 of the one or more locations 100.

### Exemplary System

FIG. 4 illustrates an exemplary computer system 400 for performing the processes 200 and 300 (shown in FIGS. 2 & 3). In the exemplary embodiment, the system 400 is used for analyzing image data to detect potential issues with properties 100 (shown in FIG. 1).

As described below in more detail, the IA computer system 410 may be programmed to analyze 240 images to detect 245 issues (both shown in FIG. 2). In addition, the IA computer system 410 may be programmed to train models 210 (shown in FIG. 2) to be used for image recognition and issue detection. In some embodiments, the IA computer system 410 is programmed to execute the models 210 as shown in FIG. 2. The IA computer system 410 may be programmed to (1) store one or more models 210 for analyzing images 235 to identify issues 245 (all shown in FIG. 2) associated with the images; (2) store a plurality of initial images 220 (shown in FIG. 2) of a location 100; (3) receive a plurality of current images 235 of the location 100; (4) execute the one or more models 210 to compare the plurality of initial images 220 to the plurality of current images 235; (5) detect one or more issues 245 at the location 100 based upon an output of the execution of the one or more models 210; and/or (6) transmit one or more notifications 250 (shown in FIG. 2) based upon the one or more issues 245 at the location 100.

In the example embodiment, user computer devices 215 are computers that include a web browser or a software application, which enables user computer devices 215 to communicate with IA computer system 410 using the Internet, a local area network (LAN), or a wide area network (WAN). In some embodiments, the user computer devices 215 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 215 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, the user computer devices 215 further include one or more cameras 405. A user may be utilizing a camera 405 to capture images of a property 100. In the exemplary embodiment, user computer device 215 is in communication with camera 405. In some embodiments, camera 405 is integrated into user computer device 215. In other embodiments, camera 405 is a separate device that is in communication with user computer device 215, such as through a wired connection, i.e., a universal serial bus (USB) connection.

In the example embodiment, tenant computer devices 230 are computers that include a web browser or a software application, which enables tenant computer devices 230 to communicate with IA computer system 410 using the Internet, a local area network (LAN), or a wide area network (WAN). In some embodiments, the tenant computer devices 230 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Tenant computer devices 230 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, the tenant computer devices 230 further include one or more cameras 405. A user may be utilizing a camera 405 to capture images of a property 100. In the exemplary embodiment, tenant computer device 230 is in communication with camera 405. In some embodiments, camera 405 is integrated into tenant computer device 230. In other embodiments, camera 405 is a separate device that is in communication with tenant computer device 230, such as through a wired connection, i.e., a universal serial bus (USB) connection.

In the example embodiment, the IA computer system 410 (also known as IA server 410) is a computer that include a web browser or a software application, which enables IA computer system 410 to communicate with user client devices 215 and/or using the Internet, a local area network (LAN), or a wide area network (WAN). In some embodiments, the IA computer system 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. IA computer system 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes one or more image classification models, images 220 and 235 (both shown in FIG. 2), and/or issue remediation information. In some embodiments, the database 420 is stored remotely from the IA computer system 410. In some embodiments, the database 420 is decentralized. In the example embodiment, a person can access the database 420 via the user computer devices 215 by logging onto IA computer system 410.

Third-party servers 425 may be any third-party server that IA computer system 410 is in communication with that provides additional functionality and/or information to IA computer system 410. For example, third-party server 425 may provide access to one or more service providers and/or suppliers. In the example embodiment, third-party servers 425 are computers that include a web browser or a software application, which enables third-party servers 425 to communicate with IA computer system 410 using the Internet, a local area network (LAN), or a wide area network (WAN). In some embodiments, the third-party servers 425 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 425 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices

### Exemplary Client Device

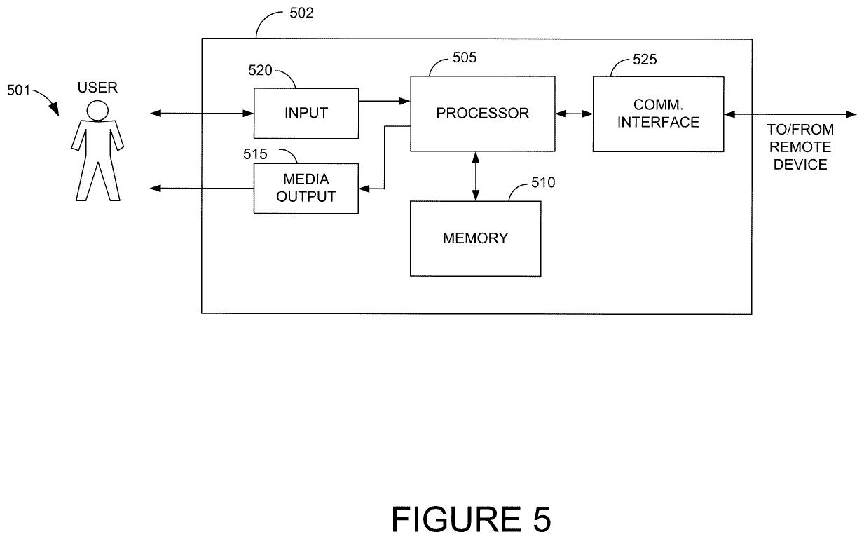

FIG. 5 depicts an exemplary configuration of user computer device 215 (shown in FIG. 2), in accordance with one embodiment of the present disclosure. User computer device 502 may be operated by a user 501. User computer device 502 may include, but is not limited to, user computer devices 215, tenant computer device 230 (both shown in FIG. 2), and IA computer device 410 (shown in FIG. 4). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for displaying instructions 225 on capturing images 235 (both shown in FIG. 2). In some embodiments, user computer device 502 may include an input device 520 for receiving input from user 501. User 501 may use input device 520 to, without limitation, captured images 235.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as IA computer device 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from IA computer device 410. A client application allows user 501 to interact with, for example, IA computer device 410. For example, instructions may be stored by a cloud service, and the output of the execution of the instructions sent to the media output component 515.

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instruction such as illustrated in FIGS. 2 and 3.

In some embodiments, user computer device 502 may include, or be in communication with, one or more applications. User computer device 502 may be configured to receive data from the one or more sensors, such as camera 405 (shown in FIG. 4) and store the received data in memory area 510. Furthermore, user computer device 502 may be configured to transmit the sensor data to a remote computer device, such as IA computer device 410, through communication interface 525.

### Exemplary Server Device

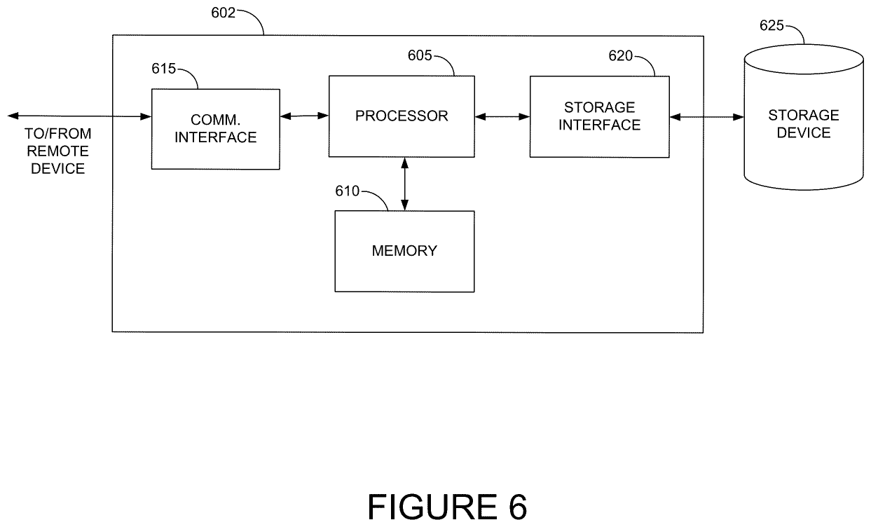

FIG. 6 depicts an exemplary configuration of a server 425 (shown in FIG. 4), in accordance with one embodiment of the present disclosure. Server computer device 601 may include, but is not limited to, database server 415, IA server 410, and third-party server 445 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, user computer device 215, tenant computer device 230 (both shown in FIG. 2), third-party server 435, and cameras 405 (shown in FIG. 4). For example, communication interface 615 may receive requests from user computer devices 230 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with database 420 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 2 and 3.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, IA computer system 410 is configured to implement machine learning, such that IA computer system 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Exemplary Embodiments

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) store one or more models for analyzing images to identify issues associated with the images; (2) store a plurality of initial images of a location; (3) receive a plurality of current images of the location; (4) execute the one or more models to compare the plurality of initial images to the plurality of current images; (5) detect one or more issues at the location based upon an output of the execution of the one or more models; and/or (6) transmit one or more notifications based upon the one or more issues at the location. The system may include additional, less, or alternate functionality, including that discussed elsewhere herein.

An enhancement of the system may include a processor configured to analyze the plurality of images. The images may be, for instance, retrieved from one or more memory units and/or acquired via one or more sensors, including cameras, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include a processor configured to receive a plurality of historical images of a plurality of properties. The system may further generate the one or more models based upon the plurality of historical images.

A further enhancement of the system may include a processor configured to receive the plurality of initial images from a user computer device associated with the location.

A further enhancement of the system may include a processor configured to transmit instructions to the user computer device for capturing the plurality of initial images.

A further enhancement of the system may include a processor configured to control the user computer device to capture the plurality of initial images.

A further enhancement of the system may include a processor configured to transmit instructions to a user computer device associated with a tenant of the location, wherein the instructions include one or more items to capture in the plurality of current images of at the location. The instructions may include an overlay to display on a display screen of the user computer device. The system may also control the user computer device to capture the plurality of current images. The system may further transmit the instructions to the user computer device of the tenant on a periodic basis.

A further enhancement of the system may include a processor configured to transmit the one or more notifications based upon the one or more issues at the location to a service provider to resolve the one or more issues.

A further enhancement of the system may include a processor configured to receive a plurality of sets of current images of a first location over a plurality of periods of time. The system may also compare the plurality of sets of current images of the first location to determine at least one trend at the first location.

A further enhancement of the system may include a processor configured to receive a plurality of sets of current images of a first location over a plurality of periods of time. The system may also calculate a score for a tenant at the first location based upon the plurality of sets of current images of the first location.

A further enhancement of the system may include a processor configured to receive a plurality of sets of current images from one or more locations associated with a landlord. The system may also calculate a score for the landlord based upon the plurality of sets of current images of the one or more locations.

In another aspect, a computer-implemented method may be provided. The computer-implemented method may be performed by a computer device including at least one processor in communication with at least one memory device. The method may include: (1) storing one or more models for analyzing images to identify issues associated with the images; (2) storing a plurality of initial images of a location; (3) receiving a plurality of current images of the location; (4) executing the one or more models to compare the plurality of initial images to the plurality of current images; (5) detecting one or more issues at the location based upon an output of the execution of the one or more models; and/or (6) transmitting one or more notifications based upon the one or more issues at the location. The computer-implemented method may include additional, less, or alternate actions, including those discussed elsewhere herein.

An enhancement of the method may include analyzing the plurality of images. The images may be, for instance, retrieved from one or more memory units and/or acquired via one or more sensors, including cameras, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders

An enhancement of the computer-implemented method may include receiving a plurality of historical images of a plurality of properties. Additionally or alternatively, a further enhancement of the computer-implemented method may include generating the one or more models based upon the plurality of historical images.

An enhancement of the computer-implemented method may include receiving the plurality of initial images from a user computer device associated with the location.

An enhancement of the computer-implemented method may include transmitting instructions to the user computer device for capturing the plurality of initial images.

An enhancement of the computer-implemented method may include controlling the user computer device to capture the plurality of initial images.

An enhancement of the computer-implemented method may include transmitting instructions to a user computer device associated with a tenant of the location, wherein the instructions include one or more items to capture in the plurality of current images of at the location. The instructions may include an overlay to display on a display screen of the user computer device. The method may also include controlling the user computer device to capture the plurality of current images. The method may further include transmitting the instructions to the user computer device of the tenant on a periodic basis.

An enhancement of the computer-implemented method may include transmitting the one or more notifications based upon the one or more issues at the location to a service provider to resolve the one or more issues.

An enhancement of the computer-implemented method may include receiving a plurality of sets of current images of a first location over a plurality of periods of time. The method may also include comparing the plurality of sets of current images of the first location to determine at least one trend at the first location.

An enhancement of the computer-implemented method may include receiving a plurality of sets of current images of a first location over a plurality of periods of time. The method may also include calculating a score for a tenant at the first location based upon the plurality of sets of current images of the first location.

An enhancement of the computer-implemented method may include receiving a plurality of sets of current images from one or more locations associated with a landlord. The method may also include calculating a score for the landlord based upon the plurality of sets of current images of the one or more locations

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store one or more models for analyzing images to identify issues associated with the images; (2) store a plurality of initial images of a location; (3) receive a plurality of current images of the location; (4) execute the one or more models to compare the plurality of initial images to the plurality of current images; (5) detect one or more issues at the location based upon an output of the execution of the one or more models; and/or (6) transmit one or more notifications based upon the one or more issues at the location. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system comprising at least one processor in communication with at least one memory device, wherein the at least one processor programmed to:
store one or more models for analyzing images to identify issues associated with the images;
store a plurality of initial images of a location;
receive a plurality of current images of the location;
execute the one or more models to compare the plurality of initial images to the plurality of current images;
detect one or more issues at the location based upon an output of the execution of the one or more models; and
transmit one or more notifications based upon the one or more issues at the location.

2. The computer system of claim 1, wherein the at least one processor is further programmed to:
receive a plurality of historical images of a plurality of properties; and
generate the one or more models based upon the plurality of historical images.

3. The computer system of claim 1, wherein the at least one processor is further programmed to receive the plurality of initial images from a user computer device associated with the location.

4. The computer system of claim 3, wherein the at least one processor is further programmed to transmit instructions to the user computer device for capturing the plurality of initial images.

5. The computer system of claim 3, wherein the at least one processor is further programmed to control the user computer device to capture the plurality of initial images.

6. The computer system of claim 1, wherein the at least one processor is further programmed to transmit instructions to a user computer device associated with a tenant of the location, wherein the instructions include one or more items to capture in the plurality of current images of at the location.

7. The computer system of claim 6, wherein the instructions include an overlay to display on a display screen of the user computer device.

8. The computer system of claim 6, wherein the at least one processor is further programmed to control the user computer device to capture the plurality of current images.

9. The computer system of claim 6, wherein the at least one processor is further programmed to transmit the instructions to the user computer device of the tenant on a periodic basis.

10. The computer system of claim 1, wherein the at least one processor is further programmed to transmit the one or more notifications based upon the one or more issues at the location to a service provider to resolve the one or more issues.

11. The computer system of claim 1, wherein the at least one processor is further programmed to:
receive a plurality of sets of current images of a first location over a plurality of periods of time; and
compare the plurality of sets of current images of the first location to determine at least one trend at the first location.

12. The computer system of claim 1, wherein the at least one processor is further programmed to:
receive a plurality of sets of current images of a first location over a plurality of periods of time; and
calculate a score for a tenant at the first location based upon the plurality of sets of current images of the first location.

13. The computer system of claim 1, wherein the at least one processor is further programmed to:
receive a plurality of sets of current images from one or more locations associated with a landlord; and
calculate a score for the landlord based upon the plurality of sets of current images of the one or more locations.

14. A computer-implemented method performed by a computer device including at least one processor in communication with at least one memory device, the method comprising:
storing one or more models for analyzing images to identify issues associated with the images;
storing a plurality of initial images of a location;
receiving a plurality of current images of the location;
executing the one or more models to compare the plurality of initial images to the plurality of current images;
detecting one or more issues at the location based upon an output of the execution of the one or more models; and
transmitting one or more notifications based upon the one or more issues at the location.

15. The computer-implemented method of claim 14 further comprising:
receiving a plurality of historical images of a plurality of properties; and
generating the one or more models based upon the plurality of historical images.

16. The computer-implemented method of claim 14 further comprising receiving the plurality of initial images from a user computer device associated with the location.

17. The computer-implemented method of claim 16 further comprising transmitting instructions to the user computer device for capturing the plurality of initial images.

18. The computer-implemented method of claim 16 further comprising controlling the user computer device to capture the plurality of initial images.

19. The computer-implemented method of claim 14 further comprising transmitting instructions to a user computer device associated with a tenant of the location, wherein the instructions include one or more items to capture in the plurality of current images of at the location.

20. The computer-implemented method of claim 19, wherein the instructions include an overlay to display on a display screen of the user computer device.

21. The computer-implemented method of claim 19 further comprising controlling the user computer device to capture the plurality of current images.

22. The computer-implemented method of claim 19 further comprising transmitting the instructions to the user computer device of the tenant on a periodic basis.

23. The computer-implemented method of claim 14 further comprising transmitting the one or more notifications based upon the one or more issues at the location to a service provider to resolve the one or more issues.

24. The computer-implemented method of claim 14 further comprising:
receiving a plurality of sets of current images of a first location over a plurality of periods of time; and
comparing the plurality of sets of current images of the first location to determine at least one trend at the first location.

25. The computer-implemented method of claim 14 further comprising:
receiving a plurality of sets of current images of a first location over a plurality of periods of time; and
calculating a score for a tenant at the first location based upon the plurality of sets of current images of the first location.

26. The computer-implemented method of claim 14 further comprising:
receiving a plurality of sets of current images from one or more locations associated with a landlord; and
calculating a score for the landlord based upon the plurality of sets of current images of the one or more locations.

27. At least one non-transitory computer-readable media having computer-executable instructions embodied thereon, wherein when executed by a computing device including at least one processor in communication with at least one memory device, the computer-executable instructions cause the at least one processor to:
store one or more models for analyzing images to identify issues associated with the images;
store a plurality of initial images of a location;
receive a plurality of current images of the location;
execute the one or more models to compare the plurality of initial images to the plurality of current images;
detect one or more issues at the location based upon an output of the execution of the one or more models; and
transmit one or more notifications based upon the one or more issues at the location.
